(19) United States
(12) Patent Application Publication
(10) Pub. No.: US 2026/0310730 A1
(43) Pub. Date: Oct. 8, 2026

(54) SYSTEM AND METHOD FOR EVALUATING SUBJECT MATTER DATA AND APPLYING THE SAME TO A VIRTUAL LANDSCAPE

(71) Applicant: Accencio LLC, Philadelphia, PA (US)

(72) Inventors: Kevin Brown, Philadelphia, PA (US); Kevin Brogle, Cream Ridge, NJ (US)

(73) Assignee: Accencio LLC, Philadelphia, PA (US)

(21) Appl. No.: 19/480,564

(22) PCT Filed: May 3, 2024
(86) PCT No.: PCT/US2024/027657

§ 371 Date: Oct. 31, 2025

Related U.S. Application Data
(60) Provisional application No. 63/463,603, filed on May 3, 2023.

(51) Int. Cl. G06F 16/9032; G06F 16/9035

(52) U.S. Cl. CPC G06F 16/90332; G06F 16/9035

(57) ABSTRACT

The system, methods and computer implemented processes described herein are directed, in one particular aspect, to evaluating a collection of subject matter documents and generating based on the mapping of the similarity or differences of the subject matter contained within the subject matter documents, one or more visual relationships between subject matter documents. In a particular implementation, a system is provided that accesses from a database of documents or content, a collection of documents or content of interest. The system further includes preparing the content contained within each of the selected documents or content. Once the content has been prepared, the system described vectorizes the content. Using the vector data, relationships between the vectorized data can be explored using a n-dimensional map or network diagram.

### CROSS REFERENCE TO RELATED APPLICATIONS

The present application claims priority to and the benefit of U.S. patent application No. 63/463,603, filed May 3, 2023, which is hereby incorporated by reference in its entirety.

### FIELD OF THE INVENTION

The present invention concerns a system and method for evaluating textual data, such as chemical identifiers obtained from source documents, using a virtual N-dimensional array. The described system and method, in part, are directed to extracting from the source documents chemical identifiers and converting those chemical identifiers into coded forms. Further aspects are directed to plotting, or identifying plot coordinates, such as a 2D or 3D plot, of coded forms in a low dimensional space, in which the location of each coded form in the space is based on the similarity of each of coded forms to one another.

### BACKGROUND OF THE INVENTION

It is known in the art to use statistical techniques to evaluate libraries of documents to extract usable information for example, U.S. Pat. No. 10,013,467, herein incorporated by reference in its entirety, teaches extracting data from source documents. Furthermore, it is known in the art to convert and manipulate chemical structures using computer analyses and algorithms. These techniques fall short of providing an environment in which the subject matter of textual documents, including those referring to chemical or biological substances, can be evaluated and compared to one another.

There exists in the art a need to evaluate and understand the contents of documents in a systematic and quantitively fashion. Furthermore, what is needed in the art is a system and a method which can construct an artificial environment which is trained around a particular subject matter target, such as a virtual manifold or a virtual array of nodes, from which common features can be identified, transformed into new coded forms and inserted into the artificial environment for determining whether its placement within the artificial environment fits at least one prescribed criterion. present invention addresses these and other needs.

### SUMMARY OF THE INVENTION

The system, methods and computer implemented processes described herein are directed, in one particular aspect, to evaluating a collection of subject matter documents and generating based on the mapping of the similarity or differences of the subject matter contained within the subject matter documents, one or more visual relationships between subject matter documents. In a particular implementation, a system is provided that obtains from a database of documents or content, a collection of documents or content of interest. The system further includes preparing the content contained within each of the selected documents or content. Once the content has been prepared, the system described vectorizes or otherwise converts this content into a form suitable for mapping. Using the vector data or other forms of mappable data, the relationships between documents that have been converted into mappable data can be explored using a n-dimensional map or network diagram.

In a further example, the subject matter of the application described herein includes, the steps of conducting a subject matter search of a database or corpus of documents. Using the results of this search, the text of each result can be evaluated and concepts or summaries of the text can be generated. A method is further provided for vectorizing or converting the summaries or extracted text. A further step includes using the vector data to generate a map detailing the relationships between the vectorized data. For example, using a n-dimensional map or network diagram, the similarity or differences between vectorized forms can be displayed visually.

These and other features and aspects will be understood from the discussion below of certain embodiments of the invention.

### BRIEF DESCRIPTION OF THE DRAWINGS

The accompanying drawings, which are incorporated in and constitute a part of this specification, illustrate aspects of the invention and together with the description, serve to explain the principles of the invention.

FIG. 1 is a component diagram of a system in accordance with certain embodiments of the invention.

FIG. 2 is a flow diagram in accordance with certain embodiments of the invention.

FIG. 3 is a schematic diagram of certain embodiments of the invention.

FIG. 4 is a flow diagram in accordance with certain embodiments of the invention.

FIG. 5 is a flow diagram in accordance with certain embodiments of the invention.

FIG. 6 is a flow diagram in accordance with certain embodiments of the invention.

FIG. 7 is a schematic diagram of interconnected components in accordance with certain embodiments of the invention.

### DESCRIPTION OF CERTAIN EMBODIMENTS OF THE INVENTION

By way of overview and introduction, the system, methods and computer implemented processes described herein are directed, in one particular aspect, to evaluating a collection of subject matter documents and generating based on the mapping of the similarity or differences of the subject matter contained within the subject matter documents, one or more visual relationships between subject matter documents. In a particular implementation, a system is provided that accesses from a database of documents or content, a collection of documents or content of interest. The system further includes preparing the content contained within each of the selected documents or content. Once the content has been prepared, the system described vectorizes the content. Using the vector data, relationships between the vectorized data can be explored using a n-dimensional map or network diagram.

In a further example, the subject matter of the application described herein includes, the steps of conducting a subject matter search of a database or corpus of documents. Using the results of this search, the text of each result can be evaluated and concepts or summaries of the text can be generated. A method is further provided for vectorizing or converting the summaries or extracted text. A further step includes using the vector data to generate a map detailing the relationships between the vectorized data. For example, using a n-dimensional map or network diagram, the similarity or differences between vectorized forms can be displayed visually.

Throughout the following discussion, the American spelling of the singular “formula” and plural “formulas” is used instead of the British spelling convention “formulae/formula.”

As used herein, “representational identifier” means a format or nomenclature utilized as a representation of particular subject matter, such as nucleotide sequences, amino acid sequences, textual summaries or syntactic fingerprints, and/or chemical entities.

As used herein, “chemical entities” comprise chemical compounds, substances and non-stoichiometric compounds.

Also, as used herein, “chemical identifiers” means any schema used to identify a specific chemical entity. For example, chemical formulas, structural formulas, chemical names derived from any chemical nomenclature, or trivial names all can be utilized in the systems and methods herein. In one particular arrangement, the chemical identifiers identify an opioid agonist (e.g. hydrocodone, morphine, hydromorphone, oxycodone, codeine, levorphanol, meperidine, methadone, oxymorphone, buprenorphine, fentanyl and derivatives thereof, dipipanone, heroin, tramadol, etorphine, dihydroetorphine, butorphanol, levorphanol). In a further arrangement, the chemical identifier identifies molecules that interact with specific G-protein coupled receptors, tyrosine kinase linked receptors, guanylate-cyclase linked receptors, nuclear steroid receptors, membrane bound steroid receptors, ligand-gated ion channel receptors or adhesion molecules.

As used herein, a “coded form” is a multivariable data representation of a particular set of information. In one arrangement, the coded form can relate to a collection of n-grams or other textual data. In the context of chemical or biological entities, the coded form can relate to structural, sequential, physical and/or binding properties of a chemical entity represented by a chemical identifier. By coding such properties, an assessment of the similarities that exist among and between different documents, biological or chemical identifiers can be made, including automated assessments.

In part, the present invention concerns generating datasets which associate the extracted chemical identifiers, the coded forms corresponding to these extracted identifiers, and links to the originating source documents. By maintaining an association between these datasets, systems and methods in accordance with embodiments of the present invention can derive relationships between the datasets based on the chemical identifiers, rather than in view of their coded forms. These relationships enhance the principal function of generating potential new chemical entities by managing and utilizing source document data based on the underlying relationships between data extracted from the source documents.

### Discussion of System Arrangement

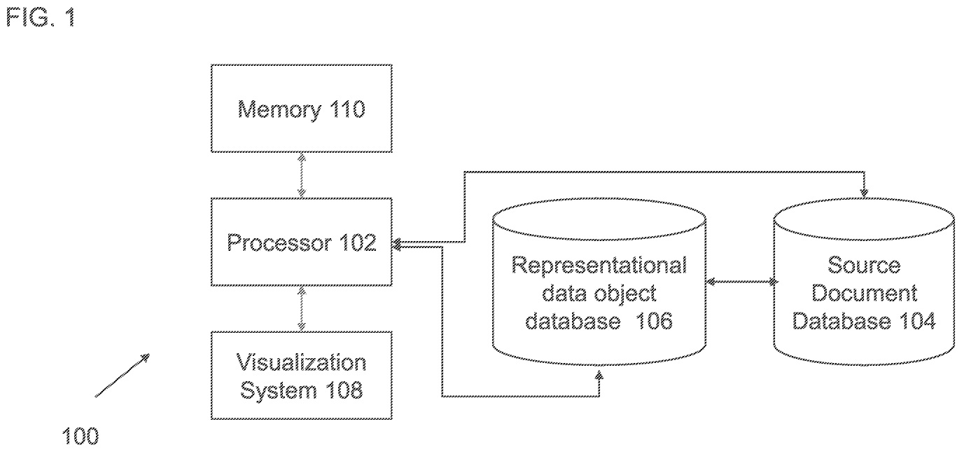

In one embodiment, the computer system 100 is illustrated in FIG. 1 and includes a computer (not shown) which has a hardware processor 102 configured to access a database 104 of stored source documents. Each stored source document contains at least information relating to a particular subject matter. In one instance the subject matter is a biological target of interest (e.g., sodium channel inhibitors,), and information describing chemical structures, formulae, antigens, amino acid sequences, or nucleotide sequences used to interact with, or related to, the biological target.

A search performed in a conventional manner on the database 104, including possibly several databases of documents, yields a universe of documents that relate in one manner or another to the biological target of interest.

In a particular embodiment of the present system, the source documents are published patent documents, including patent applications and patents, available through the United States Patent and Trademark Office, optionally from foreign patent offices and from various commercial patent databases. Other collections of non-patent documents are suitable for use with the system and method, such as, by way of example and not limitation, technical and scientific journals, research compendiums, and other documents containing information relating to chemical compounds, any or all of which can be included in the database 104. Particular advantages result, however, when the source documents include published patent documents because one effect of the predictive engine described herein is the potential to identify novel and inventive chemical or biologic formula, sequences or structures, including ones not documented in the patent literature in connection with a particular biological target.

As illustrated in the high-level block diagram of FIG. 1, the processor 102 is configured by code stored in its memory 110 to extract data from the source document database 104 and generate a collection of representational data objects that preserves the relationship between the representational data and the source document. While the present discussion is in relation to the processor 102 and the memory 110, the processor can include multiple cores, or can be embodied as a plurality of processors, each being provided with code from a respective memory, as may be implemented in a distributed computer implementation of the invention.

In one arrangement, representational data objects are amino acid sequences. In an alternative embodiment, the representational data are chemical entity identifiers. In yet a further embodiment, the representational identifiers are specific subject matter text or passages contained therein. However, for ease of discussion, the following example will use chemical identifiers to illustrate the implementation of the described embodiments.

Thus, for example, chemical entity data objects can be stored in a representational data object database 106. When evaluating chemical compounds, the representational data object database is a chemical entity data object database. Alternatively, when evaluating biologic entities or identifiers, the representational data object database 106 is a biologic data object database. In an alternative context the representational data object database is a textual data object database. In one embodiment, the processor 102 executes software modules stored in the memory 110 which configure the processor to access the database and generate predictive or analytic outputs based on the contents of the chemical entity data object database 106 and based upon algorithmic logic discussed in this specification. Through the use of code modules stored in the memory 110, the processor 102 can provide a visualization via a visualization system 108 of a virtual target landscape which is constructed and exists in the computer implementation in order to identify locations in the landscape where gaps are present in the subject matter of the database entries, thereby pointing to the possibility of new or undisclosed chemical entities (NCEs), or other subject matter not currently described in the databases. Such NCEs are not described within the universe of source documents that gave rise to the virtual landscape for the particular biological target of interest, and only a portion of potential NCEs would be of interest, such as those NCEs that occupy prescribed placements or locations within the constructed landscape.

The processor 102 is configured to perform a series of discrete steps to access, analyze and generate outputs relating to the data in the representational data object database 106 as described. As will be apparent from the accompanying discussion of methods in accordance with aspects of the invention, analysis and evaluation of subject matter of interest, including the prediction and identification of new chemical entities, or any other representational data, can, in one arrangement be performed by evaluating the virtual landscape defined by a particular algorithmic approach.

U.S. Pat. No. 10,372,713, entitled “Chemical Formula Extrapolation And Query Building To Identify Source Documents Referencing Relevant Chemical Formula Moieties” naming inventors Kevin Brown and Kevin Brogle, which is hereby incorporated by reference as if set forth in its entirety herein, describes a system and method that can be used for constructing queries that lead to the discovery or generation of potentially new subject matter. In brief, a set of specific representational identifiers that are represented or covered by a generic representational identifier found in, say, a target document, can be extrapolated and queries can be constructed and performed on a corpus of source documents for purposes of comparison of the members of the extrapolated set of specific representational identifiers to a database of known representational data. By matching known representational data in this way, any overlap between the generic representational data and specific instances of the generic representational identifier within the source documents is determined, and in specific implementations, the system and method reduces the scope of the generic representational identifier such that the reduced scope generic representational identifier encompasses only novel specific representational identifiers.

In an alternative arrangement, the extraction module implements a natural language extraction and association algorithm, comprising code executing in the processor, to extract data from the text of the document. In this arrangement, the extraction module utilizes a dictionary of weighted subject matter terms and tokens to extract information from the text of the source documents and convert that information into a computationally useful format. For example, terms commonly used in the collection of patent documents are provided with relevancy weight, such that any extraction will provide discounted values related to the presence of terms commonly found across the collection of source documents. In one embodiment, this relevancy weight is determined by calculating the frequency or uniformity of occurrence of each term in the document or within a collection of documents, or in a larger corpus of text, by assigning weighted values to each term within the document, depending on the frequency of that term or token within the corpus or collection of corpuses selected. For example, common stop words and words common to the subject matter are given a low relevance score. In one embodiment, the relevancy scores are a binary score. In another embodiment the relevancy scores are established relative to a defined relevancy range. In this way a textual fingerprint, such as a numerical or data structure representing the underlying core concepts of the corpus, is generated using the weighted values. In this context, common terms will not be used, or will have reduced relevancy, when generating a numeric representation of the textual elements of a source document that describes the subject matter contained therein. Likewise, terms that have specific technical meanings are given higher weight as they are more likely to describe the specific subject matter of the source document. Thus, collections of terms representing the subject matter of, e.g., each patent document, are generated with each term having an associated value. In a further implementation, the terms are compared to a library of generic features or concepts found within the subject matter, and scored based on the relevance, rarity and/or specificity of the terms found within each source document. These values are then used to convert the terms into a numeric representation of the subject matter of the source documents such that it can be placed within an n-dimensional manifold.

Once the subject matter of interest has been queried, it can be plotted to an n-dimensional map of nodes for visualization. A fuller description of the process of generating an N-dimensional Maps, and the visualization thereof, can be found as described in co-pending commonly owned applications Ser. No. 17/571,840; Ser. No. 17/694,477; PCT/US23/85791, as well as issued U.S. Pat. Nos. 10,013,467; 11,609,917; 10,372,713; 11,494,387, all of which are herein incorporated by references as is presented in their respective entireties.

However, briefly, it will be appreciated and understood that subject matter contained within the documents of interest can be converted into vector forms. For example, a suitably configured processor can be used to convert subject matter of a document, such as a described chemical identifier (referred to as chemical entity data object (CEDO)) into a coded form and store the converted forms in a memory or other storage location while preserving the association between the CEDO and the coded form. In one embodiment, this conversion includes implementing a MDL 960-bit SS-keyset numerical conversion algorithm, produced by MDL Information Systems, in order to convert the identifier into a numerical representation. Alternatively, other keysets such as, for example, those based on affinity-fingerprint algorithms or feature-tree algorithms, or the 881 bit structural keys used by PubChem, or 1- and 2-dimensional molecular descriptors can be implemented by the processor 102 in order to obtain coded forms of chemical identifiers, or other subject matter, including the text of the documents themselves. The following discussion uses CEDOs as an example of the functioning of the system and method provided. However, it will be appreciated by those possessing the requisite level of skill in the art that other data objects, such as textual data objects can be substituted for CEDOs when used in conjunction with corresponding databases 106, according to the following disclosure.

As used herein, the CEDOs are provided to neural networks for the purposes of determining the placement of each CEDO within an n-dimensional map. As used herein, neural networks are machine learning systems used to derive rule bases for evaluating unclassified data using pre-classified or “training” datasets. These rule bases are instructions that configure a data analysis agent, such as a processor, to classify new data passed to the system. Furthermore, the rule base is configurable such that the rule base itself is updatable, extensible or modifiable in response to new unclassified data. In the embodiment provided, the CEDOs are used both as the training data and the unclassified data.

In the one or more implementations described, a plotting module configures the processor 102 to generate an n-dimensional space as the landscape and seed it with placeholder values. The placeholder values in this example are selected to cover the range of potential numerical values for the converted coded (e.g., numerical) forms of the CEDOs. In a particular embodiment, the plotting module includes code to further configure the processor to insert each CEDO at a location in the n-dimensional space. In the illustrated example, the particular location for the insertion operation is a function of the degree of similarity that the coded form shares with the placeholder data or to other coded forms previously placed in the n-dimensional space. Here, the coded forms are used to plot the CEDOs to a given coordinate location in the n-dimensional space according to the similarity of the coded forms of each of the CEDOs to one another and to the placeholder values. It should be understood, however, that one embodiment of the systems and methods described herein utilizes the plot coordinates to compute the degree of similarity without actually plotting the CEDOs to a visualization or other output device.

The above processing functions can operate as a series of programmed steps performed by a properly configured computer system using one or more modules of computer-executable code. For instance, a set of software modules can be configured to cooperate with one another to provide prediction information regarding new chemical entities to a display device as described herein. In this regard, there can be a database access modules, search modules, filtering modules, extraction modules, conversion modules, plotting modules, prediction modules, and visualization modules.

Each of these modules can comprise hardware, code executing in a computer, or both, that configure a machine such as the computing system 100 to implement the functionality described herein. The functionality of these modules can be combined or further separated, as understood by persons of ordinary skill in the art, in analogous embodiments of embodiments of the invention.

The processor 102 of the described invention is configurable for connection to remote storage devices and computing devices. For example, the processor of the described computer system may, in one embodiment, be configured for communication with a mobile computing device, or connecting via the internet to a remote server.

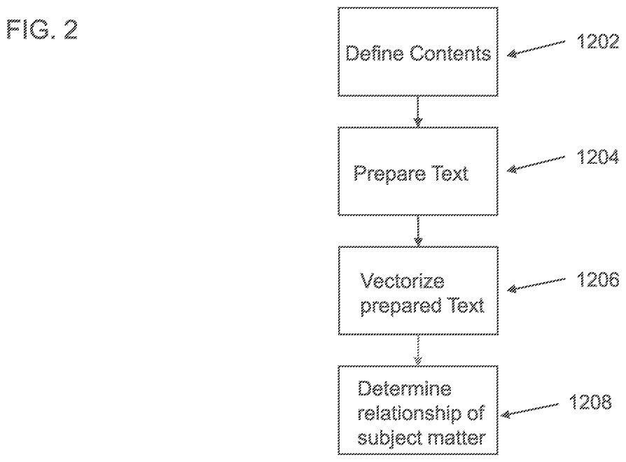

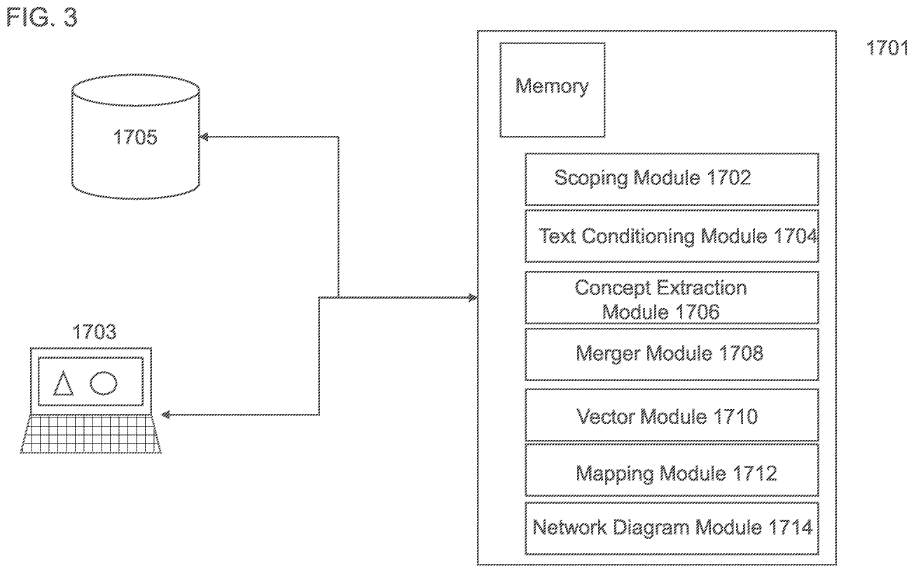

Turning now to a further example and implementation, FIGS. 2 and 3, one or more steps are executed by a processor or a system described herein to evaluate the relationship between the subject matter present within a collection of documents. While the foregoing explanation utilizes patents or patent applications as examples, it will be appreciated that documents containing other subject matter (product or content descriptions, fiction and non-fiction works, texts with musical notation., etc.) are understood and appreciated.

In a particular arrangement, a processor or system described herein is configured to access, process and display information to a user. For example, in one or more arrangements, a processor is configured to evaluate the relationship, and the strength of that relationship, between the subject matter contained within different source documents. This relationship can be visualized using an n-dimensional map or a network diagram. Depending on the specific output of the described system, one or more of the processors described herein are configured to provide a visualization of the relationships between different subject matter containing documents or references, identify gaps or “white space” that exists in a given subject matter area, or show subject matter areas of particular concentration.

With particular reference to the flow diagram of FIG. 2, one or more software modules are executed by one or more text analysis processors. These modules are configured as code and are executable by the processor upon direct user interaction or as the result of receiving an input from another module. When executed by one or more of the processors of the system described, the executed modules are configured to generate a relationship between the subject matter of the source documents. This relationship can be further visualized or provided to one or more further analysis systems.

In a further arrangement, the visualizations created by the suitably configured text analysis processor are based on the relationship between the vectorized subject matter described therein. For example, patent documents describing similar subject matter are grouped together in a network diagram showing the relationship between different patents and patent applications based on the subject matter described therein. In yet a further arrangement, the network diagram showing the relationship among a collection of documents can be determined based on the language (such as but not limited to specific n-grams) contained within the source documents.

As shown in step 1202, a collection of documents is obtained for evaluation. Here, one or more processors of the text analysis system described are configured by a scoping module 1702 to define the scope or contents of an analysis group, as shown in FIG. 13. In a particular implementation, one or more scoping modules 1702 configure one or more processors to receive user input data relating to the desired relationship determination. For example, a user of the subject matter analysis system 1701 described accesses one or more user interfaces directly connected to the relevant processor(s) that allow for the submission of a target query. In alternative implementations, the user is able to send a query to one or more processors of the text analysis system 1701.

In one arrangement, the scope of the query relates to a subject matter of interest to the user. For example, the subject matter can relate to a specific drug product, composition or formula or combination thereof. Here, such a query for subject matter can relate to a drug or other compound. Furthermore, the subject matter of interest could relate to the specific indication of the drug of interest, its molecular or structural type, the routes of administration, or any combination thereof.

Alternatively, the scope of the query could be to the manufacturer or supplier of such a compound or drug product.

In one or more implementations, the user interface can be a separate software application that receives and processes the user's query. For example, the separate software application is a remote software application that is executing on a remote processor 1703 configured to communicate with the one or more processors described herein. In one particular implementation, the separate software application 1703 provides a user interface that is configured to receive a user supplied query. This user supplied query can be provided directly to the processors described herein (such as through a direct, local network, or internet connection). Alternatively, the separate software application 1703 is configured to first convert the user supplied query into a form and format suitable for use herein. For example, the separate software application 1703 is configured to cause the user's query to be supplied to one or more natural language processing modules or remote applications that are configured to parse the natural language of the user query and produce a structured or pre-determined format output that corresponds to the user's query.

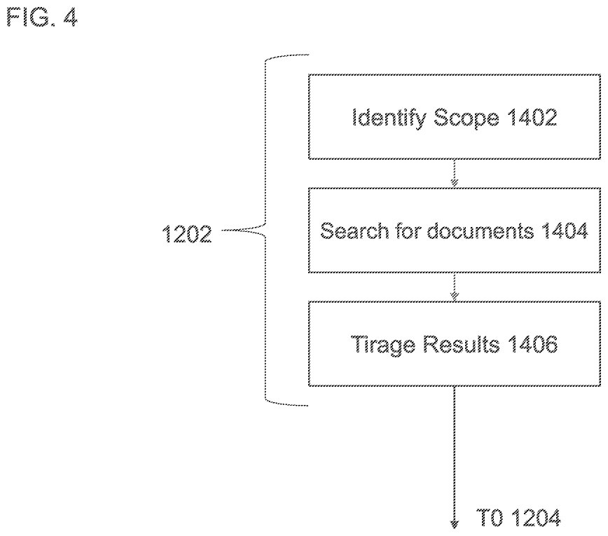

Turning now to the flow diagram of FIG. 4, it will be appreciated that one or more processors are configured by a collection of software modules to define or evaluate the contents of the subject matter search to be performed and the results obtained.

For instance, in one or more implementations, the subject matter target of interest is described in one or more documents. For example, in one particular implementation the subject matter of interest is a drug product whose structure or formulation is described within a corpus of documents that are electronically accessible and searchable. Here, a user can enter a search query to identify the scope of particular interest, as shown in step 1402. The corpus of documents is configured as a collection or database of documents. The document database 1705 can be, in one particular implementation, be a curated collection of documents. For instance, a curated document database can contain, in one arrangement, patents, patent applications and other documents relating to a particular entity. For example, the document database includes a collection of patents, research papers, laboratory notes and other information owned by a pharmaceutical company or research institution.

In another example, a curated database is a literature database or patent database maintained by a university or other organization such as a commercial publishing firm. Here, such information may or may not be accessible to the public. In alternative arrangements, the document database 1705 is not curated. In one or more further implementations an uncurated database is a collection of accessible, or otherwise public, scientific, technical, and medical journals or documents. By way of example, the uncurated document database can, in one implementation, be represented by the United States Patent and Trademark Office patent database. However, in another arrangement, an uncurated database includes pre-print or published compilations of technical or other literature.

With specific reference to the steps outlined in FIGS. 2 and 4, in one or more implementations, the documents queried are queried for subject matter containing the subject matter of interest. For example, where the query is directed to a particular indication (such as treatment for glaucoma), the documents to be searched each describe some feature or aspect of glaucoma treatment. As described herein, in one or more implementations, the documents to be searched contain chemical and biological identifiers (chemical formula and/or nucleotide sequences). By way of particular example, the biological target of interest relates to a known or suspected glaucoma treatment using a specific compound or class of compounds.

Continuing with the flow diagram provided in FIG. 4, as shown in step 1404, a search query is executed over the contents of the document database to identify documents describing the subject matter of interest. In one or more particular implementations, a search can entail querying the document database 1705 for a specific ailment, such as glaucoma or a specific form of cancer. Such queries are conducted on either the curated or uncurated database to produce a collection of results. For ease of explanation and in no way limiting, in the foregoing examples the search query is executed over a curated database of patents and patent applications. However, in another arrangement, the search query is executed over an uncurated database of patents and patent applications accessible from the USPTO or the World Intellectual Property Office (WIPO) database or another database provided by either a private entity or a governmental organization.

In yet a further implementation, the query is executed over a large language model (LLM) that has been trained on a corpus of documents relevant to the search query. For example, the LLM is trained on a corpus of patent documents accessible from the USPTO or WIPO patent databases. Here, the search query is provided as an input to the trained LLM and the output generated is then provided to the processor for use in the steps described herein.

In one or more implementations, the document database 1705 is configured to receive a search query. Such a search query can be in the form of search strings, prose, or one or more unique numerical or alphanumeric identifiers. The document database 1705 is configured to return, in response to these search parameters, a collection documents relating to the search query. In one or more implementations, the collection of documents relating to the search query are individual documents, such as individual patent and patent application documents. However, in an alternative arrangement, the results returned are in the form of links or data to a particular record. For example, the database is configured to store information relating to a given patent document in a structured format, such as XML, HTML, JSON or another interoperable data format. Here, a collection of structured format files or datasets are provided in response to a query.

In one or more further implementations, the results of the database query are evaluated for relevancy, as shown in step 1406. Here, in one or more implementations, the results can be passed to an evaluation system configured to evaluate the patents. By way of non-limiting example, each patent returned from an uncurated database is first passed to a relevancy processor configured to evaluate the relevancy of the result to the initial query. In one arrangement, the relevancy processor is a natural language processor, or large language model that has been trained to receive the full text of the results of the query and the initial query and generates a relevancy score for each document. Using this document score, each document that is above a pre-determined relevancy threshold is classified or flagged as relevant and saved for further use.

In a further or alternative implementation, the results returned from the search query step 1404 are evaluated for further processing and integration into the visualizations described herein, as shown in step 1406. For example, in one or more further implementations, the results of the query are filtered or processed prior to further use. By way of non-limiting example, a processor is configured by code executing therein to filter the query results. Here, duplicate query results can be removed from the returned set. One or more datasets or individual files representing query results are compared to one another by a suitably configured processor. Where the comparison indicates that two or more datasets or files represent the same database entry, one or more of the database entries are removed from the dataset.

In yet a further implementation, one or more machine learning, large language models or natural language processing (NLP) modules or models are used to evaluate each of the results returned in the query. Here, the machine learning or natural language processing modules are used to evaluate the similarity between two results in the returned results of the query. For example, the NLP modules configure the processor to compare word frequencies, tokens, n-grams or other elements of a particular returned results with other returned results to identify highly similar documents. Where the machine learning or natural language processing model or module determines that the likelihood that two or more results are the same is above a given threshold, one or more of the results is removed from the query results dataset.

Once the query results have been filtered or evaluated to contain only those entries of interest, each of the query results are further processed to extract information used to determine the relationship, as shown in step 1204.

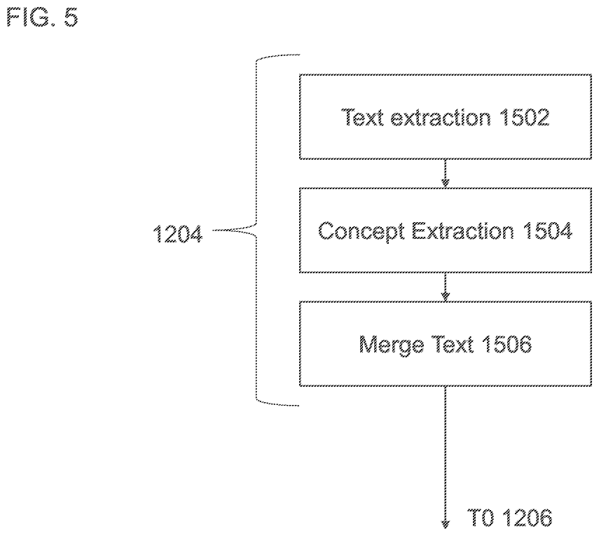

For example, one or more sub steps are used to extract texts, concepts and general information from the search results. As shown in FIGS. 3 and 5, where the query results are patents and patent applications, a text conditioning module 1704 configures one or more processors of the subject matter evaluation system 1701 to evaluate each returned search query result and extract key portions thereof, as shown in step 1504. In one particular configuration, the text conditioning module 1704 configures one or more processors to evaluate a patent document in a structured file format, such as XML or JSON, and extract fields or key pairs that relate to the title, abstract, claims or selected elements of the specification. Where the query result is a patent document, the text conditioning module 1704 configures the processor to implement one or more NPL processes to extract text corresponding to meaningful portions of the text, such as the title, abstract, key components of the specification or other portions of the patent or patent application. In one or more specific implementations, the text conditioning module 1704 causes the extracted text to be saved to a local or remote database for further processing.

Once the relevant text has been extracted from each of the query results, a concept extraction module 1706 configures one or more processors of the described system to extract concepts from the text obtained in step 1504. For example, the concept extraction module 1706 configures one or more processors of the described system to evaluate the extracted text using one or more NPL processes and remove standard stop words or custom stop words. In one arrangement, one or more processors of the described system is configured to access a library or dictionary of standard stop words, or subject matter specific stop words, and use these custom dictionaries to extract the concepts described in the text.

For example, the NLP removes stop words from a set of patent claims to condense the patent claims into just the relevant terms. By way of example, the stop word library may include commonly encountered terms like “comprising”, “the”, “one or more” and the like.

In a further arrangement, a concept extraction module 1706 configures the one or more processors of the described system to access one or more libraries or classifiers to identify concepts within the extracted text. For example, based on NPL processing, the concept extraction module 1706 configures the processor to compare text extracted from the query entry to a library of concepts. Where there is a match for a given concept, the query entry is flagged or classified as containing the identified concept.

Using these combined or classified terms, the processor can be configured to generate a custom dictionary of reduced or combined terms described in a given query result. This custom dictionary can be used to represent the particular query result. For example, through the described process, each query result is transformed into a custom dictionary of concepts and terms. The contents of this custom dictionary can then be used in the analysis and comparison of multiple query entries.

Once all of the terms and phrases of the extracted text have been classified, the extracted text can be reduced for ease of further processing, as shown in step 1506. In one arrangement, a merger module 1708 configures one or more processors of the described system to merge or combine synonymous terms and phrases. For example, where the extracted text contains multiple different nomenclatures referring to the same chemical compound or biological entity, the merger module 1708 configures a processor of the system 1701 described to combine these terms under a single classifier.

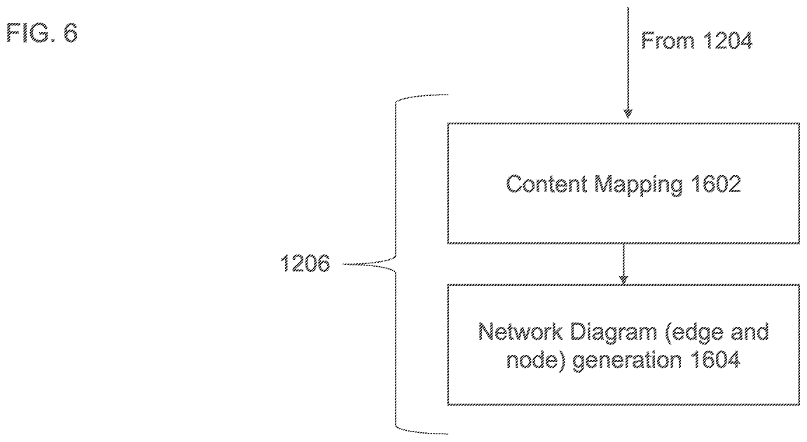

Turning now to step 1206, and shown in more detail in FIG. 6, the custom dictionary for each query entry that has been generated is converted into a vector. For example, a vector module 1710 creates n-grams for concepts for each query entry. For example, the vector module 1710 configures one or more processors of the described system to assign numeric values to each of the concepts or terms associated with a particular query result. As used herein, vectorization of n-grams refers to the process of representing text data that has been converted into n-grams (contiguous sequences of n items, such as but not limited to words) as numerical vectors in a high-dimensional space. The vector module 1710 configures a processor of the system described to receive each custom dictionary, or n-grams relating to the given query result and count the occurrences of each n-gram in the text data, which creates a frequency count matrix.

In a further implementation, the vector module 1710 configures one or more processors of the system described to convert the frequency count matrix into a numerical vector representation, using techniques such as term frequency-inverse document frequency (TF-IDF) or word embedding models like Word2Vec or GloVe. In an alternative arrangement, the vector module 1710 configures one or more processors to use TF, TF-IDF, and other processes, such as TF-PDF.

It will be appreciated that as used herein, TF stands for Term Frequency and is a numerical representation of the frequency of a term in a document. Specifically, it is defined as the number of times a term appears in a document divided by the total number of terms in the document. This measure reflects how important a term is to a particular document, with more frequent terms being considered more important. TF-IDF refers to Term Frequency-Inverse Document Frequency and is a technique used to represent the importance of a term in a corpus (i.e., a collection of documents). Here, the use of TF-IDF algorithms is to take into account both the frequency of a term in a document (TF) and the frequency of the term across all documents in the corpus (IDF). Specifically, the IDF score for a term is calculated as the logarithm of the total number of documents in the corpus divided by the number of documents in which the term appears. Here, the corpus is the collection of query search results. The TF-IDF score for a term in a document is then the product of the TF score and the IDF score. This measure helps to identify terms that are important in a particular document, but are not overly common in the corpus as a whole.

In one or more further arrangements, the numeric values generated by the vector module 1710 are optionally weighted by the location of specific terms within the overall structure of the query result. For example, more weight would be given to a concept expressed in the claims of the patent or patent application than would be given to the same concept expressed in the ‘background’ section of the same patent or patent application.

Now turning to step 1602, once the query result has been converted into a vector, each vector (representing the collection of query documents) can be placed within a generated n-dimensional map, using a mapping module 1712. The process for placing and organizing the map using a sufficiently configured processor has been described herein, for example, in commonly owned U.S. Pat. No. 10,372,713, which is herein incorporated by reference as if presented in its entirety, and with further particular reference to at least steps 242-250 and FIG. 2B, therein.

In one or more further implementations, once the map has been generated the distances between the vectors can be established. For example, as shown in step 1604 one or more processors is configured to select a distance metric. In one particular implementation, the distance metric is a Euclidean distance metric. However, one possessing an ordinary level of skill in the art would appreciate that other alternative distance metrics are also envisioned in understood, such as Manhattan cosine and other distance metrics.

In one or more further implementations, a processor of the system 1701 described is configured to calculate distance pairs for two or more vectors. In one particular instance, the one or more processors are configured to calculate one way pairing functions for a pair of vectors. Once all of the distances between the various pairs of vectors have been calculated the map can be filtered based on those pairs that are within a threshold of a preset filter distance. In yet a further implementation, one or more processors of the system described are configured to create files based on the generated n-dimensional map.

Once the distance metrics have been calculated, one or more processors of the relationship system described is configured by a network diagram module 1714. For example, using a network diagram module 1714, the one or more processors of the relationship system are configured to determine a relationship between one or more documents returned in the search query based on the vector distance. For instance, the one or more processors of the network diagram system are configured to generate an edge file, as shown in step 1604. Here, an edge file contains information about each connection between two nodes. Specifically, the edge file contains information about which nodes are connected. Furthermore, information in the edge file indicates if the connection between nodes has a direction, and if so, what is the direction of the connection. Further information in the edge file includes the distance between the nodes as well as any other property that can be attributed to the connection between nodes.

In one or more further implementations, the edge file generated by the processor includes distance statistics and the underlying structure or sequence information for the included vectors.

In a further implementation, one or more processors of the relationship system described is configured to generate a node file, as shown in step 1604. Here, the node file contains information related to each node. For example, the node file contains the relevant molecular or biological structure, the source document, the properties of the molecule or document (such as but not limited to the authors of the document, the owner of the source patent, etc.). For example, in one or more instances where the chemical or biological identifier in the node is described within a patent, the node file includes patent information, such as filing date, expiration date, and other information.

Once both the edge and node files are created, a network diagram can be implemented or created based on the associated pair vector pairs as shown in step 1604. For example, using the distance pair calculations the processor is configured to provide a network diagram that only includes those distance pairs that are within the predefined threshold. In one or more implementations, the network diagram can be created, and then minimized, using Yifan Hu proportional, Fruchterman Reingold in original Reingold or Expansion techniques.

It will be appreciated that the network diagram includes the information from the node and edge files. This information includes the source documents for each of the mapped vectors. By way of example, where the source documents are patents or patent applications, mapping the identified or categorized concepts or terms within each document or query result provides for an improved approach to visualize relationships. For example, using a patent-based network or graph provides a new and better way to group patents by subject matter. Here such a subject matter-based network or graph allows for the identification of key references or documents that show the evolution or transformation of one concept into another. In turn, this network-based approach allows for a new avenue to understand how subject matter may evolve or stagnate over time or across a corpus of documents.

In one implementation, the statistical analysis sub-module configures the processor to implement one or more linear classifier algorithms (e.g. Support Vector Machine Algorithm, Naïve Bayes Classifier, unsupervised learning algorithms and/or logistic regression) on data related to the converted or mapped data. In one implementation, the unsupervised learning algorithm (e.g., the self-organizing map algorithm previously described) is determines, using code that configures the processor, how a portfolio of references or documents owned by an entity is developed over time, such as by identifying latent traits or parameters that are useful in predicting future development. For example, the processor implements an unsupervised learning algorithm to evaluate the changes in subject matter or content described in source documents owned by an entity over time and extracts predictive information related to the changes. In another arrangement the processor is configured by code to evaluate the change in the number of nodes occupied by chemical identifiers described in source documents owned by an entity over time and to identify variables or parameters that are statistically linked to the change in the number of nodes. In these manners, predictive models can be generated and utilized by the statistical analysis sub-module.

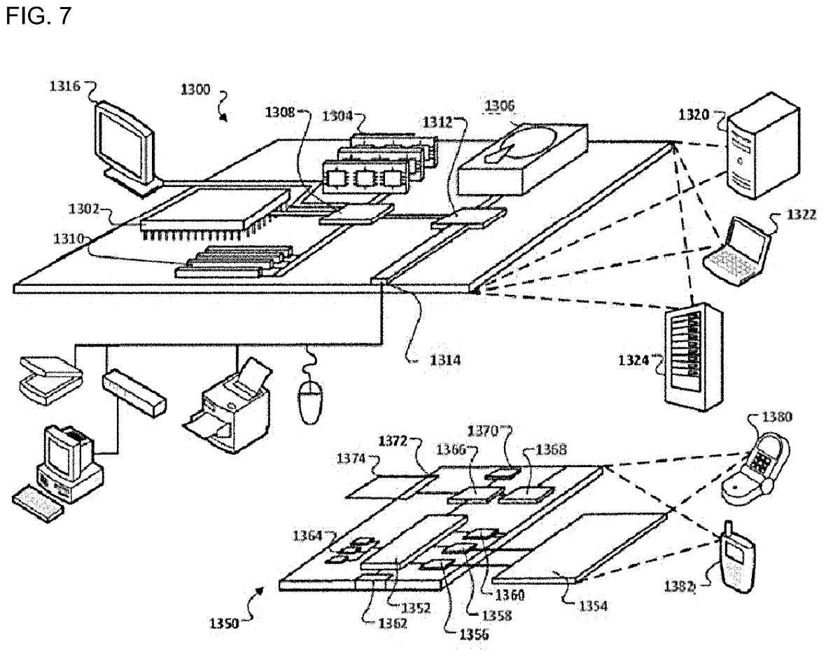

As illustrated in FIG. 7, the computing system 1300 and includes a processor 1302, a memory 1304, a storage device 1306, a high-speed interface 1308 connecting to the memory 1304 and multiple high-speed expansion ports 1310, and a low-speed interface 1312 connecting to a low-speed expansion port 1314 and the storage device 1306. Each of the processor 1302, the memory 1304, the storage device 1306, the high-speed interface 1308, the high-speed expansion ports 1310, and the low-speed interface 1312, are interconnected using various buses, and can be mounted on a common motherboard as shown in FIG. 7, or in other manners as appropriate. The processor 1302 can process instructions for execution within the computing device 1300, including instructions stored in the memory 1304 or on the storage device 1306 to display graphical information for a GUI on an external input/output device, such as a display 1316 coupled to the high-speed interface 1308. In other embodiments, multiple processors and/or multiple buses can be used, as appropriate, along with multiple memories and types of memory. Also, multiple computing devices can be connected, with each device providing portions of the necessary operations (e.g., as a server bank, a group of blade servers, or a multi-processor system).

A mobile computing device 1350 may include a processor 102, a memory 1364, and an input/output device such as a display 1354, a communication interface 1366, and a transceiver 1368, among other components. The mobile computing device 1350 can also be provided with a storage device, such as a micro-drive or other device, to provide additional storage. Each of the processor 1352, the memory 1364, the display 1354, the communication interface 1366, and the transceiver 1368, are interconnected using various buses, and several of the components can be mounted on a common motherboard or in other manners as appropriate.

The processor 1352 can communicate with a user through a control interface 1358 and a display interface 1356 coupled to the display 1354. The display 1354 can be, for example, a TFT (Thin-Film-Transistor Liquid Crystal Display) display or an OLED (Organic Light Emitting Diode) display, or other appropriate display technology. The display interface 1356 can comprise appropriate circuitry for driving the display 1354 to present graphical and other information to a user. The control interface 1358 can receive commands from a user and convert them for submission to the processor 1352. In addition, an external interface 1362 can provide communication with the processor 1352, so as to enable near area communication of the mobile computing device 1350 with other devices. The external interface 1362 can provide, for example, for wired communication in some embodiments, or for wireless communication in other embodiments, and multiple interfaces can also be used.

The memory 1364 stores information within the mobile computing device 1350. The memory 1364 can be implemented as one or more of a computer-readable medium or media, a volatile memory unit or units, or a non-volatile memory unit or units. An expansion memory 1374 can also be provided and connected to the mobile computing device 1350 through an expansion interface 1372, which can include, for example, a SIMM (Single In Line Memory Module) card interface. The expansion memory 1374 can provide extra storage space for the mobile computing device 1350, or can also store applications or other information for the mobile computing device 1350. Specifically, the expansion memory 1374 can include instructions to carry out or supplement the processes described above, and can include secure information also. Thus, for example, the expansion memory 1374 can be provided as a security module for the mobile computing device 1350, and can be programmed with instructions that permit secure use of the mobile computing device 1350. In addition, secure applications can be provided via the SIMM cards, along with additional information, such as placing identifying information on the SIMM card in a non-hackable manner.

It should be understood that various combinations, alternatives and modifications of the present invention could be devised by those skilled in the art in view of this disclosure. The present invention is intended to embrace all such alternatives, modifications and variances that fall within the scope of the appended claims. While the invention has been particularly shown and described with reference to a preferred embodiment thereof, it will be understood by those skilled in the art that various changes in form and details may be made therein without departing from the spirit and scope of the invention

The mobile computing device 1350 can communicate wirelessly through the communication interface 1366, which can include digital signal processing circuitry where necessary. The communication interface 1366 can provide for communications under various modes or protocols, such as GSM voice calls (Global System for Mobile communications), SMS (Short Message Service), EMS (Enhanced Messaging Service), or MMS messaging (Multimedia Messaging Service), CDMA (code division multiple access), TDMA (time division multiple access), PDC (Personal Digital Cellular), WCDMA (Wideband Code Division Multiple Access), CDMA2000, or GPRS (General Packet Radio Service), among others. Such communication can occur, for example, through the transceiver 1368 using a radio-frequency. In addition, short-range communication can occur, such as using a Bluetooth, WiFi, or other such transceiver (not shown). In addition, a GPS (Global Positioning System) receiver module 1370 can provide additional navigation-and location-related wireless data to the mobile computing device 1350, which can be used as appropriate by applications running on the mobile computing device 1350.

The mobile computing device 1350 can also communicate audibly using an audio codec 1360, which can receive spoken information from a user and convert it to usable digital information. The audio codec 1360 can likewise generate audible sound for a user, such as through a speaker, e.g., in a handset of the mobile computing device 1350. Such sound can include sound from voice telephone calls, recorded sound (e.g., voice messages, music files, etc.) and sound generated by applications operating on the mobile computing device 1350.

The mobile computing device 1350 can be implemented in a number of different forms, as shown in FIG. 8. For example, it can be implemented as a cellular telephone 1380. It can also be implemented as part of a smart-phone 1382, personal digital assistant, or other similar mobile device.

Various embodiments of the systems and techniques described here can be realized in digital electronic circuitry, integrated circuitry, specially designed ASICs (application specific integrated circuits), computer hardware, firmware, software, and/or combinations thereof. These various embodiments can include embodiment in one or more computer programs that are executable and/or interpretable on a programmable system including at least one programmable processor, which can be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms machine-readable storage medium and computer-readable storage medium refer to any non-transitory computer program product, apparatus and/or device (e.g., magnetic discs, optical disks, memory, Programmable Logic Devices (PLDs)) used to provide machine instructions and/or data to a programmable processor, including a machine-readable storage medium that receives machine instructions as a machine-readable signal. The term machine-readable signal refers to any signal used to provide machine instructions and/or data to a programmable processor. A non-transitory machine-readable storage medium does not include a transitory machine-readable signal.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server 1324), or that includes a middleware component (e.g., an application server 1320), or that includes a front end component (e.g., a client computer 1322 having a graphical user interface or a Web browser through which a user can interact with an embodiment of the systems and techniques described here), or any combination of such back end, middleware, or front end components. The components of the system can be interconnected by any form or medium of digital data communication (e.g., a communication network). Examples of communication networks include a local area network (LAN), a wide area network (WAN), and the Internet.

The computing system can include clients and servers. A client and server are generally remote from each other and typically interact through a communication network. The relationship of client and server arises by virtue of computer programs running on the respective computers and having a client-server relationship to each other.

The computing system can include clients and servers. A client and server are generally remote from each other and typically interact through a communication network. The relationship of client and server arises by virtue of computer programs running on the respective computers and having a client-server relationship to each other.

Additional Implementations of the approaches provided herein:

Point 1. A computer-implemented method for generating an artificial environment within a memory of a computer, in which chemical identifiers that relate to a particular subject matter and which are described in at least one document are extracted and analyzed, the method comprising: submitting, in electronic form, a search to at least one document database for documents describing the subject matter using a defined search strategy; extrapolating, to a first array within the memory of the computer, at least one chemical identifier described in at least one document returned from the search, the extrapolating step using an extraction module comprising code executing in a processor; transforming each chemical identifier in the first array into a respective coded form having a range of values using a conversion module comprising code executing in the processor; populating the respective coded forms into a second array within the memory of the computer; generating a virtual n-dimensional array of nodes configured to encompass the range of values in the second array using a node array generator module comprising code executing in the processor, each node of the virtual n-dimensional array having an associated weight vector value based on the range of values in the second array; placing each coded form in the second array into a node of the virtual n-dimensional array according to an unsupervised learning algorithm using a placement module comprising code executing in the processor to effect a placement; and outputting a visual representation of the virtual n-dimensional array.

While this specification contains many specific embodiment details, these should not be construed as limitations on the scope of any embodiment or of what can be claimed, but rather as descriptions of features that can be specific to particular embodiments of particular embodiments. Certain features that are described in this specification in the context of separate embodiments can also be implemented in combination in a single embodiment. Conversely, various features that are described in the context of a single embodiment can also be implemented in multiple embodiments separately or in any suitable sub-combination. Moreover, although features can be described above as acting in certain combinations and even initially claimed as such, one or more features from a claimed combination can in some cases be excised from the combination, and the claimed combination can be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing can be advantageous. Moreover, the separation of various system components in the embodiments described above should not be understood as requiring such separation in all embodiments, and it should be understood that the described program components and systems can generally be integrated together in a single software product or packaged into multiple software products.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising”, when used in this specification, specify the presence of stated features, integers, steps, operations, elements, and/or components, but do not preclude the presence or addition of one or more other features, integers, steps, operations, elements, components, and/or groups thereof.

It should be noted that use of ordinal terms such as “first,” “second,” “third,” etc., in the claims to modify a claim element does not by itself connote any priority, precedence, or order of one claim element over another or the temporal order in which acts of a method are performed, but are used merely as labels to distinguish one claim element having a certain name from another element having a same name (but for use of the ordinal term) to distinguish the claim elements.

Also, the phraseology and terminology used herein is for the purpose of description and should not be regarded as limiting. The use of “including,” “comprising,” or “having,” “containing,” “involving,” and variations thereof herein, is meant to encompass the items listed thereafter and equivalents thereof as well as additional items.

Particular embodiments of the subject matter described in this specification have been described. Other embodiments are within the scope of the following claims. For example, the actions recited in the claims can be performed in a different order and still achieve desirable results. As one example, the processes depicted in the accompanying figures do not necessarily require the particular order shown, or sequential order, to achieve desirable results. In certain embodiments, multitasking and parallel processing can be advantageous.

While the invention has been particularly shown and described with reference to a preferred embodiment thereof, it will be understood by those skilled in the art that various changes in form and details may be made therein without departing from the spirit and scope of the invention.

1. A computer system comprising: one or more processors; and one or more computer-readable media having thereon computer-executable instructions that are structured such that, if executed by the one or more processors, the computing system would be configured to evaluate a collection of subject matter documents, by being configured to perform the following:
receiving a plurality of subject matter documents for analysis;
converting each of the plurality of documents into a respective coded form, wherein each of the plurality of documents are converted into a plurality of n-grams and the coded form for each of the plurality of documents is generated using the respective plurality of n-grams;
populating the respective coded forms into an array within the memory of the one or more processors;
generating a virtual n-dimensional array of nodes configured to encompass the range of values in the array, wherein each node of the virtual n-dimensional array having an associated weight vector value based on the range of values in the array;
placing each coded form in the array into a node of the virtual n-dimensional array according to an unsupervised learning algorithm; and
providing to a display device, a Q dimensional visualization of the virtual n-dimensional array.

2. The computer system of claim 1, wherein the Q-dimensional visualization is a 3-dimensional visual representation of the virtual n-dimensional array wherein the 3-dimensional visual representation includes visual indicators identifying the respective coded form of each of the plurality of documents, wherein the distance between visual indicators correlates to the degree of similarity between the plurality of documents.

3. The computer system of claim 1, further comprising: calculating a distance metric for a plurality of pairs of coded forms placed within the virtual n-dimensional array.

4. The computer system of claim 3, further comprising: determining the similarity between a pair of coded forms based on the calculated distance metric.

5. The computer system of claim 1, wherein the plurality of documents are the results of a search query.

6. The computer system of claim 1, further comprising generating the plurality of subject matter documents by receiving a user query from a user; providing the user query to at least one natural language processing model, and receiving from the natural language processing model a reformatted query.

7. The computer system of claim 6, wherein the user query is a chemical compound provided in a first subject matter nomenclature and the reformatted query is provided in an alternative subject matter nomenclature.

8. The computer system of claim 7, further comprising: providing the user query to a least one database of subject matter documents and receiving the plurality of subject matter documents from the database.

9. The computer system of claim 7, further comprising providing the user query to a large language model, and receiving from the large language model the plurality of documents.

10. The computer system of claim 1, wherein the computer system is further configured for accessing each of the plurality of subject matter documents and filtering the plurality of documents based on the relevancy of the each of the plurality of documents to the user query.

11. The computer system of claim 10, wherein filtering the plurality of documents further comprises providing each of the plurality of documents to a natural language processor to generate a relevancy score that correspond to the relevancy each of the plurality of documents has to the user query, and selecting those plurality of documents that have a calculated relevancy score that exceeds a pre-determined threshold.

12. The computer system of claim 11, wherein filtering the plurality of documents further comprises providing each of the plurality of documents to a natural language processor to generate a similarity score that corresponds to the similarity each of the plurality of documents to each of the other plurality of documents, and based on the similarity score, classifying a one of the plurality of documents as a duplicate document, and filtering the plurality of documents to remove the duplicate document.

13. The computer system of claim 1, wherein converting each of the plurality of documents into a respective coded form includes conditioning each of the plurality of documents into a conditioned form, wherein conditioning comprises providing each of the plurality of documents to at least one or more natural language processors that is configured to evaluate the text of each of the plurality of documents and remove at least a portion of the text thereof based on a custom dictionary to generate a plurality of condensed references.

14. The computer system of claim 13 further comprising, providing each of the condensed references to one or more natural language processing models configured to identify at least one of a plurality of identified concepts, and generating for each of the condensed references a concept array of identified concepts recited within the condensed reference.

15. The computer system of claim 14, further comprising, converting the contents of each concept array into a vector for placement within the virtual n-dimensional array.

16. The computer system of claim 15, further comprising converting, for each array, the contents thereof into a plurality of n-grams, calculating the occurrence of each of the n-grams within the text of the reference, and generating, based on the calculating, a frequency count matrix.

17. The computer system of claim 16, further comprising, converting the frequency count matrix into a numerical vector representation.

18. A computer-implemented method for generating an artificial environment within a memory of a computer, in subject matter relating to a particular concept described in at least one document are extracted and analyzed, the method comprising: submitting, in electronic form, a search to at least one document database for documents describing the subject matter using a defined search strategy; extrapolating, to a first array within the memory of the computer, at least one subject matter concept described in at least one document returned from the search, the extrapolating step using an extraction module comprising code executing in a processor; transforming each concept in the first array into a respective coded form having a range of values using a conversion module comprising code executing in the processor, wherein each of the plurality of documents are converted into a plurality of n-grams and the coded form for each of the plurality of documents is generated using the respective plurality of n-grams; populating the respective coded forms into a second array within the memory of the computer; generating a virtual n-dimensional array of nodes configured to encompass the range of values in the second array using a node array generator module comprising code executing in the processor, wherein each node of the virtual n-dimensional array having an associated weight vector value based on the range of values in the second array; placing each coded form in the second array into a node of the virtual n-dimensional array according to an unsupervised learning algorithm using a placement module comprising code executing in the processor to effect a placement; calculating a distance metric for a plurality of pairs of coded forms placed within the virtual n-dimensional array; generating at least one node and at least one edge file corresponding to those plurality of pairs of coded forms that have a distance metric below a pre-determined threshold; using the at least one node and at least one edge file, generating a network diagram of the plurality of pairs of coded forms that have a distance metric below a pre-determined threshold; and outputting a visual representation of the network diagram of coded forms.

19. A computer-implemented method for generating an artificial environment within a memory of a computer, in which subject matter that relate to a particular concept and which are described in at least one document are extracted and analyzed, the method comprising: submitting, in electronic form, a search to at least one document database for documents describing the concept using a defined search strategy; receiving search results, wherein each search result includes a document identification value corresponding to a source document; accessing a numericized database of numericized concepts, wherein each entry in the numericized database includes reference to at least one document identification value; obtaining a collection of numericized concepts based on the document identification values within the search results; generating a virtual n-dimensional array of nodes configured to encompass the range of numericized identifiers using a node array generator module comprising code executing in the processor, wherein each node of the virtual n-dimensional array having an associated weight vector value based on the range of values in the second array; placing each coded form in the second array into a node of the virtual n-dimensional array according to an unsupervised learning algorithm using a placement module comprising code executing in the processor to effect a placement; calculating a distance metric for a plurality of pairs of coded forms placed within the virtual n-dimensional array; generating at least one node and at least one edge file corresponding to those plurality of pairs of coded forms that have a distance metric below a pre-determined threshold; using the at least one node and at least one edge file, generating a network diagram of the plurality of pairs of coded forms that have a distance metric below a pre-determined threshold; and outputting a visual representation of the network diagram of coded forms.
